(19) United States
(12) Patent Application Publication
(10) Pub. No.: US 2009/0213295 A1
(43) Pub. Date: Aug. 27, 2009

(54) LCD DEVICE

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/568,040

(22) PCT Filed: Apr. 11, 2005
(86) PCT No.: PCT/IB2005/051179

§ 371 Date: Oct. 18, 2006

(30) Foreign Application Priority Data
Apr. 23, 2004 (EP) 04101714.6

(51) Int. Cl. G02F 1/13357

(52) U.S. Cl. 349/62

(57) ABSTRACT

The invention relates to a liquid crystal display device (10), comprising a spectral trim filter (18) arranged in the light path between the backlight system (14) and the LCD filter panel (12). The trim filter is adapted to reduce the amount of illumination light within selected wavelength ranges in order to enhance the color gamut of the display. The trim filter is also adjustable between a filtering state for wide gamut and a transmitting state for high brightness.

### FIELD OF THE INVENTION

The present invention relates to a direct view liquid crystal display (LCD) device.

### BACKGROUND OF THE INVENTION

Standard LCD systems of today rely on a mosaic color filter pattern incorporated in an LCD panel. Each color element is typically comprised of an absorbing filter element which passes the desired color towards the viewer while absorbing undesired color components. Illumination light for incidence upon the LCD panel is provided by a backlight system, typically comprising fluorescent lamps. The spectral properties of the backlight system (the phosphors) are matched to the spectral properties of the filter element in the LCD panel to obtain proper colors according to the EBU (European Broadcasting Union) standard, or close to this standard or some other standard.

However, in many display applications, it is desired to have a color gamut that is wider than what is offered by conventional display systems. This desire is driven by some new applications, such as desktop publishing, photo editing, high quality DVD images, and the increasingly important e-commerce. All these applications would benefit from a possibility to display more “true” colors for the viewer/user than what is currently offered. In other words, a display of wider color gamut would be beneficial.

As known in the art, the color gamut of a display system is the full range of colors that can be produced by the system. Typically, the color gamut of a display system is indicated by means of a color triangle in a chromaticity diagram. A larger color triangle in the chromaticity diagram means a wider color gamut.

In previous attempts to produce improved color gamut for liquid crystal display systems, it has been proposed to use light-emitting diodes (LEDs) for the backlight. However, the performance of the LEDs is usually not satisfactory for display systems. For example, the lifetime of blue light-emitting diodes is too short for practical applications.

Moreover, in an LCD system, the use of more saturated primary colors would lead to a penalty in the form of lower brightness for the display. There is also a risk that the number of displayed colors will be reduced. For example, if each of the red, green and blue color channels is capable of providing 8 bits of gray levels (256 levels), the overall system is capable of providing 256*256*256 different colors. Hence, the source data information should be displayed within this color space. Now, if the source data is limited according to EBU standard, any increase in the color gamut for the display system will lead to fewer colors actually being displayed to the viewer. This could lead to noticeable deterioration of the image, in particular considering the fact that the number of 256 gray levels per channel was originally selected as a result of human perception tests. The difference between two adjacent gray levels is then just below perception for the human eye, and if the number of actual gray levels is reduced, this will become noticeable for the viewer.

In addition, attempts to improve the color gamut mostly lead to new requirements regarding the LCD panel, and consequently to costly modifications of the production process for such panels.

Hence, for EBU limited source data, the color gamut of a direct view LCD system should preferably adhere to the EBU ranges. On the other hand, there are various applications where the source data define a larger color space. For this latter case, there is a general desire to have a wider color gamut for the display system.

Consequently, for a display system using a standard LCD panel, there is a trade-off between how to obtain high brightness for EBU source data and how to obtain wide color gamut for source data having wider color information.

### SUMMARY OF THE INVENTION

The present invention has as an object to provide an improved liquid crystal display device.

The invention is defined by the independent claims. The dependent claims define advantageous embodiments.

The incorporation of a spectral trim filter according to the present invention can be made for a standard LCD panel, essentially without any modifications of the panel as such. This provides a very economical solution. According to the invention, it is proposed to include a chromatic trim filter that cuts away (absorbs or reflects) certain parts of the illuminating light, such as the backlight. This gives primary colors that are “purer”, thus spanning a larger color triangle. At the same time, the trim filter is adjustable between a filtering state for wide gamut and a transmitting state for high brightness.

Improved color gamut can be achieved either by reducing the amount of illumination light within the selected wavelength ranges or by entirely blocking light within certain wavelength ranges. Although the technical effect of the present invention is obtained when there is only a reduction of the amount of light within the selected wavelength ranges, it is preferred to have a trim in the form of a band pass filter, substantially completely blocking light outside of the pass bands. The amount of gamut widening can then be selected by designing the width of the pass bands appropriately.

As mentioned in the introduction, spectral trim filtering of the primary colors in a direct view LCD system in order to widen the color gamut will result in a reduced brightness for the display. Depending on the source data to be displayed (being EBU limited or describing a larger color space), either wide color gamut or maximum brightness can be desired. Thus, the present invention provides a display having an adjustable trim filter that can be set for wide gamut or high brightness. Preferably, the trim filter could also be set to intermediate states between maximum gamut and maximum brightness, in order to allow optimal viewing conditions. The setting of the trim filter can advantageously be made by the user/viewer.

An advantage of the present invention is thus that the color gamut of existing LCD displays can be improved, essentially without any further modifications of the system than the inclusion of the trim filter element. In principle, the design of the LCD panel need not be modified. This means that existing manufacturing methods and standard LCD panels can be maintained, while still permitting a wider color gamut in situations where this is desired.

The present invention is based on the recognition that a wider color gamut can be obtained by filtering away certain chromatic components of the light illuminating the LCD display. Typically, yellow and bluish-green components in the illumination light will be filtered out in order to provide increased spectral purity for the primary colors red, green and blue as provided by the color filter panel. In this way, the color coordinates of the primary colors of the color filter panel as viewed by an observer are pushed away from the center of the color triangle, effectively leading to a wider color gamut for the system. Moreover, it is recognized that the increase in color gamut entails a decrease in display brightness. Therefore, in order to adapt the display to different operating conditions, the present invention proposes the use of an adjustable spectral trim filter for selectively filtering out certain wavelength components of the illuminating light from the backlight system before it reaches the LCD panel.

### BRIEF DESCRIPTION OF THE DRAWINGS

In the following detailed description of preferred embodiments, it will be elucidated how the invention can be carried out. In the detailed description, reference is made to the drawings, in which:

FIG. 1 schematically shows a display product comprising a liquid crystal display device according to the present invention;

FIG. 2 illustrates a typical emission spectrum for the backlight system;

FIG. 3 illustrates the effect of the spectral trim filter;

FIG. 4 shows the color gamut with and without a spectral trim filter;

FIGS. 5a-5c schematically show a first embodiment of the present invention; and

FIGS. 6a-6c schematically show a second embodiment of the present invention.

On the drawings, like parts are designated by like reference numerals.

### DETAILED DESCRIPTION OF PREFERRED EMBODIMENTS

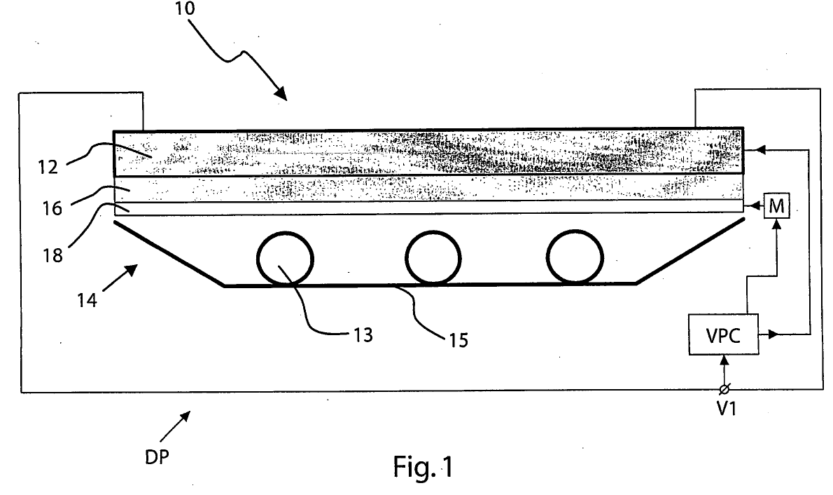

FIG. 1 shows schematically a display product DP comprising a liquid crystal display device 10 according to a general embodiment of the present invention and video processing circuitry VPC. The video processing circuitry VPC has an input for receiving an input signal V1, for example, an antenna signal or a signal from a video source such as a DVD player. The product may have a reflective or transmissive type LCD. It may be a direct view LCD or a projector for front or rear projection. In case of a projector the backlight is formed by a collimated optical system. The LCD device 10 comprises a standard LCD panel 12 for producing an image on the display, and a backlight system 14 for providing illumination onto the LCD panel. In this case, the backlight system comprises a number of fluorescent tubes 13 arranged in front of a reflector 15 for directing the light emitted by the tubes onto the LCD panel 12. Between the light source 13 of the backlight system and the LCD panel, there is provided a diffuser 16 for diffusing the light emitted by the backlight system. In addition, a spectral trim filter 18 according to the present invention is provided between the diffuser and the backlight system. It should be noted that the backlight system 14, including the lamps 13 and the reflector 15, as well as the diffuser 16 and the LCD panel 12 could be standard components. The spectral trim filter 18 according to this invention could be incorporated in most, or even all, existing LCD systems for providing adjustability of the color gamut thereof. The trim filter 18 may be made adjustable by a motor M. This motor M may be controlled by a user, for example, via a remote control (not shown) or be controlled by the video processing circuitry VPC.

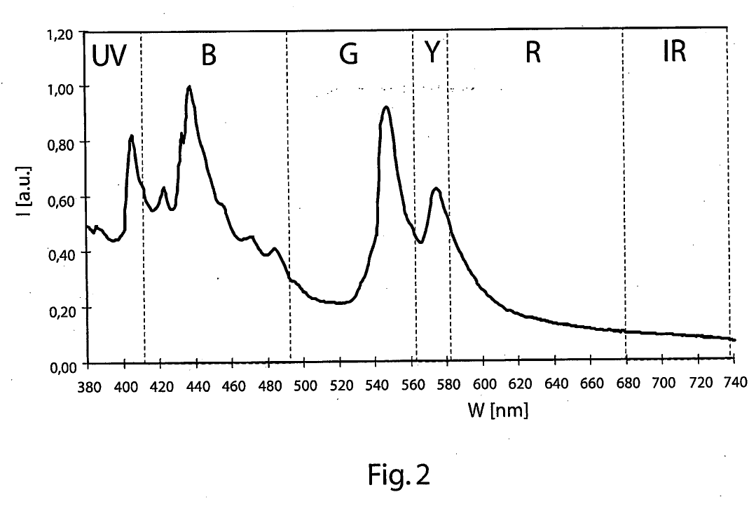

FIG. 2 shows a typical emission spectrum of a backlight system for an LCD. The intensity I is shown in arbitrary units as a function of the wavelength W in nanometers. Also an indication is given of the colors of the light related to the wavelength W: UV indicates ultraviolet light, B, G, Y, R indicate blue, green, yellow and red light, respectively, and IR indicates infrared light. As known in the art, the LCD panel comprises pixel filters for filtering this light in order to produce a color image by selectively transmitting the desired wavelengths in each color pixel. In a typical LCD system, the image is built up from three primary colors, these being red, green and blue. The color gamut of the system is determined, to a large degree, by the saturation of these primary colors. Namely, a large wavelength range for each of the primary colors will give a narrower color gamut for the system. In particular, the greenish-blue and yellowish components of the illumination light from the backlight system lead to limitations with respect to the color gamut.

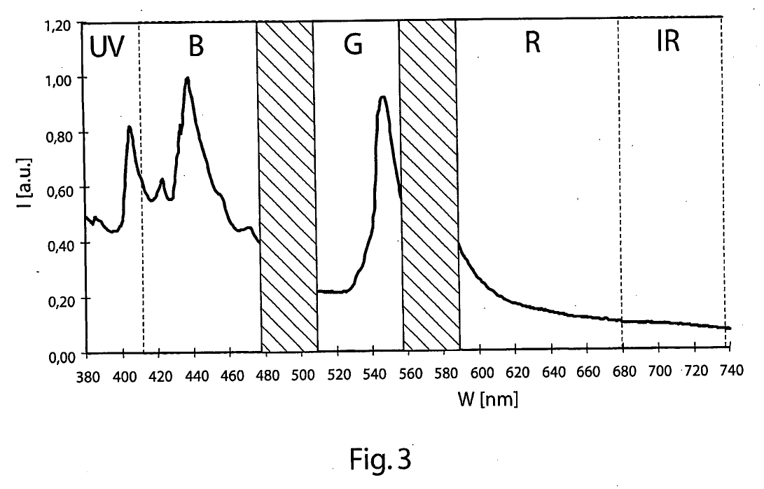

To produce an image, the illumination light from the backlight is selectively passed through the red, green and blue (RGB) color pixels of the LCD panel. However, the emission from the backlight also includes spectral components near the spectral edges of the three primary colors. For most LCD panels, such spectral components will be passed through the panel and appear in the image produced, thus reducing the color gamut of the display. Yellow and bluish-green spectral components will appear in the RGB pixels. To avoid this, and to provide a wider color gamut, the present invention proposes the use of the spectral trim filter between the LCD panel and the backlight system. The characteristics for a typical trim filter are schematically shown in FIG. 3, where it is indicated (hatched regions) that the long-wavelength portions of the blue and green spectral components are filtered out before the backlight reaches the LCD panel. The problem of limited spectral selectivity of the LCD panel will then be alleviated, since primary colors of deeper hue illuminate the panel.

Typically, the spectral trim filter filters out spectral components of the backlight around 490 nm (bluish-green) and around 570 nm (yellow). Preferably, the filtered out portions of the backlight are at least 20 nm in width. For example, the spectral trim filter can block, or reduce the amount of, light from the backlight system in a first region approximately between 475 nm and 505 nm, and in a second region approximately between 555 nm and 590 nm.

Thus, the function of the spectral trim filter is to filter out certain wavelength components of the backlight, effectively leading to a deeper color hue (larger saturation) for the primary colors and thereby to a wider color gamut for the system. To this end, bluish-green and yellowish components of the backlight are filtered out from the light reaching the LCD panel, as illustrated by the hatched areas in FIG. 3.

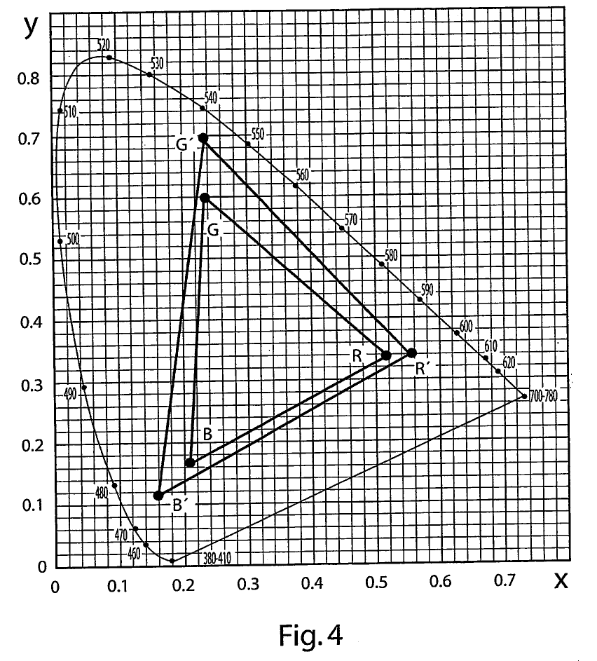

The effect of the spectral trim filter on the color gamut, for the case illustrated in FIG. 3, is illustrated in FIG. 4. The figure shows a color triangle (in a chromaticity diagram according to CIE 1931) for a standard LCD module, such as is used in portable computers and desktop LCD monitors. The points R, G and B indicate the primary colors without the spectral trim filter. The LCD module is designed according to EBU (European Broadcasting Union) standards.

The figure also shows a corresponding, larger color triangle for the case when the trim filter is present, where R′, G′ and B′ indicate the primary colors. The light transmitted by the red, green and blue filters of the LCD panel now contains narrower spectral bands, meaning that the color coordinates for these colors are pushed away from the center of the color triangle. The result is a wider color gamut covering the entire EBU color gamut, and also permitting colors outside the EBU standard to be obtained.

However, while the color gamut of the display is improved by the trim filter, the brightness will be somewhat lowered since backlight is actually filtered away. Therefore, the present invention provides for adjustable trim filter arrangements.

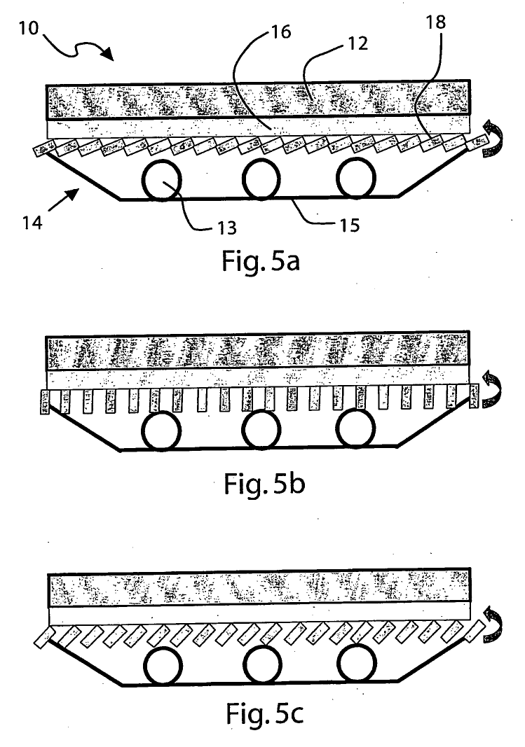

In one embodiment, the spectral trim filter is arranged on pivotable or rotatable blinds, as illustrated in FIGS. 5a-c. Such blinds can be pivoted, rotated or otherwise adjusted between one state (FIG. 5a) where the trim filter covers substantially all the area between the backlight and the LCD panel, thus giving full gamut improvement (but reduced brightness), and another state (FIG. 5b) where the trim filter blinds are adjusted away in order to pass substantially all light from the backlight in order to maximize the brightness. The first state (FIG. 5a) is called the filtering state for wide gamut, and the second state (FIG. 5b) is called the transmitting state for high brightness. Advantageously, the trim filter can also be adjusted to intermediate states, as illustrated in FIG. 5c, in order to obtain a desired setting of gamut/brightness.

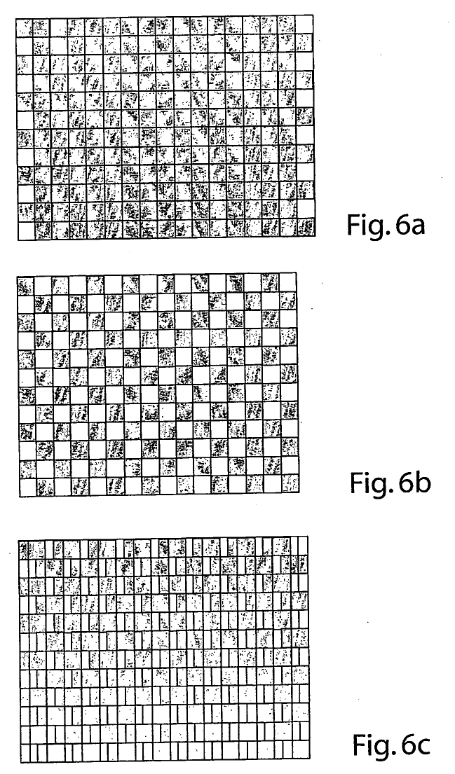

In another embodiment, the trim filter is arranged in the form of patterned first and second filter elements, as illustrated in FIGS. 6a-6c. It should be noted that only the trim filter is shown, the other components of the LCD device being left out for the sake of clarity. Each of the first and second filter elements comprises both filtering areas and non-filtering areas. In the non-filtering areas, which are void of any trim filter, substantially all of the backlight will be transmitted towards the LCD panel. The filter elements could be formed as plates, cylinders or in any other suitable shape.

The filter elements are movable with respect to each other, such that the two elements can either overlap entirely to provide minimum gamut widening and the highest brightness, or entirely non-overlapping to provide maximum gamut widening.

For the second case, where the patterned filter elements complement each other as shown in FIG. 6a, all light emitted by the backlight system will be filtered before reaching the LCD panel. In effect, the filtered parts of the spectrum can never reach the LCD panel or the eyes of the viewer. This setting of the filter element thus gives the widest color gamut for the system.

For the first case, where the patterned filter elements are entirely overlapping as shown in FIG. 6b, half of the light emitted by the backlight system is transmitted directly to the LCD panel without filtering, and half of the light is filtered. This setting of the filter elements thus gives the maximum brightness for the system. It should be noted that if the trim filter areas are comprised of reflective filters, the blocked portions of the backlight will be recycled in the backlight system. Most of this light will eventually be passed through the non-filtering parts and thus reach the LCD panel, further adding to the brightness of the display.

In addition, the filter elements can be set to partially overlap as shown in FIG. 6c, in order to produce gamut and brightness between the above two outer limits.

In order to achieve full gamut widening, the two filter elements should have complementary filtering areas such that they can be adjusted to jointly form a spectral trim; filter without non-filtering apertures.

Preferably, each of the two filter elements has filtering regions covering about 50% of the respective area. Thereby, when the filter elements are adjusted for high brightness, the largest possible amount of light is passed to the LCD panel without being filtered.

Alternatively, only one of the first and second filter elements is patterned, while the second one is having a complementary pattern, which completely blocks (or preferably reflects) any light, while the remainder is completely open. If the patterns are on top of each other, the patterned part of the first element is completely blocked by the blocking part of the second element. The open part of the second element is aligned with the non-patterned part of the first element, so light is passed without filtering through these parts.

If the patterns are shifted to be complementary, then the openings in the first element are blocked by the blocking part of the second element. So, in this case the light is filtered by the patterned part of the first element and the wide color gamut is obtained.

For each of the embodiments described above, the setting (adjustment) of the trim filter to wide gamut or high brightness can advantageously be controlled by the user.

It is preferred that the spectral trim filter is comprised of a dichroic interference filter. As known in the art, interference filters are typically made up of a plurality of transparent layers of different refractive indices. Such filters can be tailor made to reflect any desired wavelength ranges. For the present invention, the filter is designed to have reflection peaks at the wavelengths which should be eliminated from the backlight. The filter can be made on any suitable substrate, such as glass plates, plastic plates, thin plastic films, etc.

Instead of interference filters, it is also possible to use absorption-based filters, such as filters comprising absorbing dyes.

For large area displays, the trim filter should preferably be positioned at a location where the area traversed by the illumination light is small, such as adjacent the end surface of light guides in the backlight system, or around the light sources thereof.

One or each of the filter elements may be made movable by hand by providing a mechanical shifting facility or may be made movable by the motor M. Preferably there is provided a feedback to the video processing circuitry VPS related to the actual relative position of the filter elements. This enables the adaptation of the video processing of the video signal V1 in dependence on the setting of the trim filter.

The trim filter may be made adjustable depending on the video signal V1 to be displayed on the color filter panel 12. In this case the video processing circuitry VPC (see FIG. 1) analyzes the content of subsequent video images to be displayed and adjusts the trim filter, so as to provide the best possible reproduction of the input signal. The adjusting of the trim filter is realized by controlling the motor M for moving at least one of the filter elements.

### CONCLUSION

By including a spectral trim filter in an LCD device, certain spectral portions of the illumination light incident upon the LCD panel are filtered out. In this way, the spectral purity of the primary colors is increased, leading to a wider color gamut for the display. However, by filtering out selected spectral components of the illumination light, the overall brightness of the display is reduced. In some situations, the increased color gamut is not needed, or even undesired. Therefore, the trim filter is adjustable between a filtering state for wide gamut and a transmitting state for high brightness. The inclusion of the trim filter can be made substantially without altering other properties of a standard LCD device. Therefore, the present invention can be implemented for standard LCD panels without modifying the production parameters thereof.

It should be noted that the above-mentioned embodiments illustrate rather than limit the invention, and that those skilled in the art will be able to design many alternative embodiments without departing from the scope of the appended claims. For example, the allocation of the features in the various blocks of software or hardware may be changed without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A liquid crystal display device (10), comprising:
a color filter panel (12);
a backlight system (14) for sending illumination light onto said filter panel, wherein said filter panel is operative to selectively transmit desired colors of light from the backlight system (14) towards a viewer; and
and adjustable spectral trim filter (18) arranged in the light path between the backlight system (14) and the filter panel (12), said trim filter being adapted to reduce the amount of illumination light within selected wavelength ranges in order to enhance the color gamut of the display.

2. A display device according to claim 1, wherein said spectral trim filter is adjustable between a filtering state for wide gamut and a transmitting state for high brightness.

3. A display device according to claim 2, wherein the spectral trim filter is adapted to substantially block the illumination light within the selected wavelength ranges when adjusted to the filtering state.

4. A display device according to claim 1, wherein the spectral trim filter is provided on a plurality of rotatable blinds.

5. A display device according to claim 1, wherein the spectral trim filter comprises at least two separate filter elements, at least one having a patterned structure of filtering areas, said filter elements being movable with respect to each other in order to jointly provide a variable color gamut.

6. A display device according to claim 5, wherein said filter elements have complementary patterned structures of filtering and transmitting areas.

7. A display device according to claim 5, wherein the spectral trim filter has a checkerboard structure of filter areas on said filter elements.

8. A display device according to claim 1, wherein the spectral trim filter is comprised of a dichroic interference filter.

9. A display device according to claim 1, wherein the spectral trim filter comprises absorbing elements.

10. A display device according to claim 9, wherein the spectral trim filter comprises absorbing dyes.

11. A display device according to claim 1, wherein the spectral trim filter encircles a light source of the backlight system.

12. A display device according to claim 1, wherein the spectral trim filter is arranged adjacent to an end surface of a light guide in the backlight system.

13. A display device according to claim 1, wherein the spectral trim filter is adapted to reduce or block the amount of illumination light within a first wavelength range around 490 nm and within a second wavelength range around 570 nm.

14. A display device according to claim 13, wherein each of said first and second wavelength ranges is at least 20 nm wide.

15. A display product comprising the display device (10) as claimed in claim 1, and video processing circuitry (VPC) for supplying an image signal to the display device (10).
